(19) United States
(12) Patent Application Publication
(10) Pub. No.: US 2008/0248167 A1
(43) Pub. Date: Oct. 9, 2008

(54) Processed Meat Products Comprising Structured Protein Products

(75) Inventors: Matthew K. McMindes, Chesterfield, MO (US); Valdomiro Valle, Jandira-Sao Paolo (BR)

Correspondence Address: Solae, LLC, 4300 Duncan Avenue, Legal Department E4, St. Louis, MO, 63110, US

(73) Assignee: SOLAE, LLC, St. Louis, MO (US)

(21) Appl. No.: 12/057,834

(22) Filed: Mar. 28, 2008

Related U.S. Application Data
(60) Provisional application No. 60/910,291, filed on Apr. 5, 2007.

(51) Int. Cl. A23L 1/314; A23L 1/31; A23L 1/315; A23L 1/325; A23L 1/317

(52) U.S. Cl. 426/92; 426/641; 426/646; 426/644; 426/643; 426/647

(57) ABSTRACT

The present invention provides processed meat compositions comprising structured protein products having substantially aligned protein fibers and reprocessed meat products. The processed meat products of the invention have improved nutritional profiles and favorable textural characteristics.

### FIELD OF THE INVENTION

The present invention provides processed meat compositions and food products. In particular, the processed meat compositions comprise a structured protein product and a reprocessed animal meat product.

### BACKGROUND OF THE INVENTION

During the manufacture of processed meat products, some products inevitably break or split during the processing steps. Although these broken products or leftover bits and ends are edible, they are not commercially marketable. Typically, food manufacturers “rework” these leftover pieces into new meat formulations. The levels of leftover pieces reworked into new formulations typically do not exceed about 10%, whereas the amount of rework generated is typically much greater. The food industry, therefore, needs a more efficient means to utilize the pieces leftover from the manufacture of processed meat products.

Recent advances in food science have led to the development of technology to produce structured protein products having textural properties characteristic of animal striated muscle meat. The technology comprises taking an unstructured protein product with no visible grain or texture and converting it into a structured protein product with substantially aligned protein fibers. This structured protein product may be formulated into a variety of meat products or simulated meat products that have improved firmness, texture, and chewiness relative to meat emulsions formed with comminuted meat and/or unrefined soy protein materials. Processed meat products comprising this structured protein product may provide a vehicle for the increased utilization of pieces leftover during the manufacture of processed meat products, and in general could be used to improve utilization of processed meats that are not leftover pieces.

### SUMMARY OF THE INVENTION

One of the aspects of the invention provides a processed animal meat composition comprising a structured protein product having substantially aligned protein fibers and a reprocessed animal meat product. The processed meat composition of the invention optionally may further comprise uncooked animal meat in the formulation.

Another aspect of the invention encompasses food products comprising the processed animal meat compositions of the invention.

Other aspects and features of the invention are described in more detail below.

### REFERENCE TO COLOR FIGURES

The application contains at least one photograph executed in color. Copies of this patent application publication with color photographs will be provided by the Office upon request and payment of the necessary fee.

### FIGURE LEGENDS

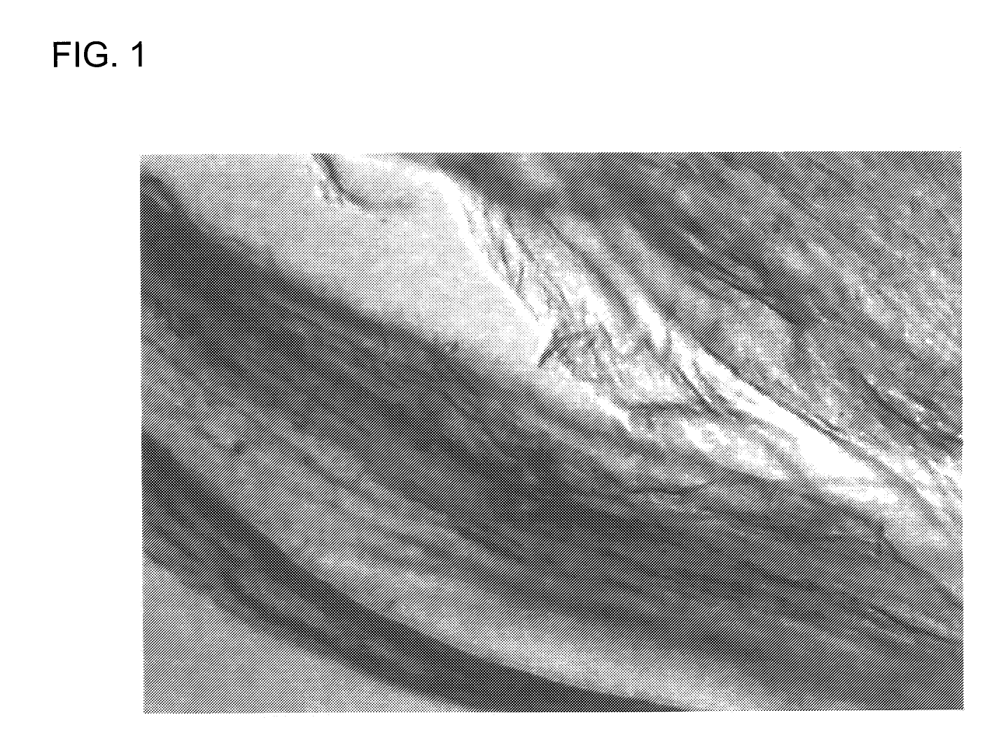

FIG. 1 depicts an image of a micrograph showing a structured protein product of the invention having protein fibers that are substantially aligned.

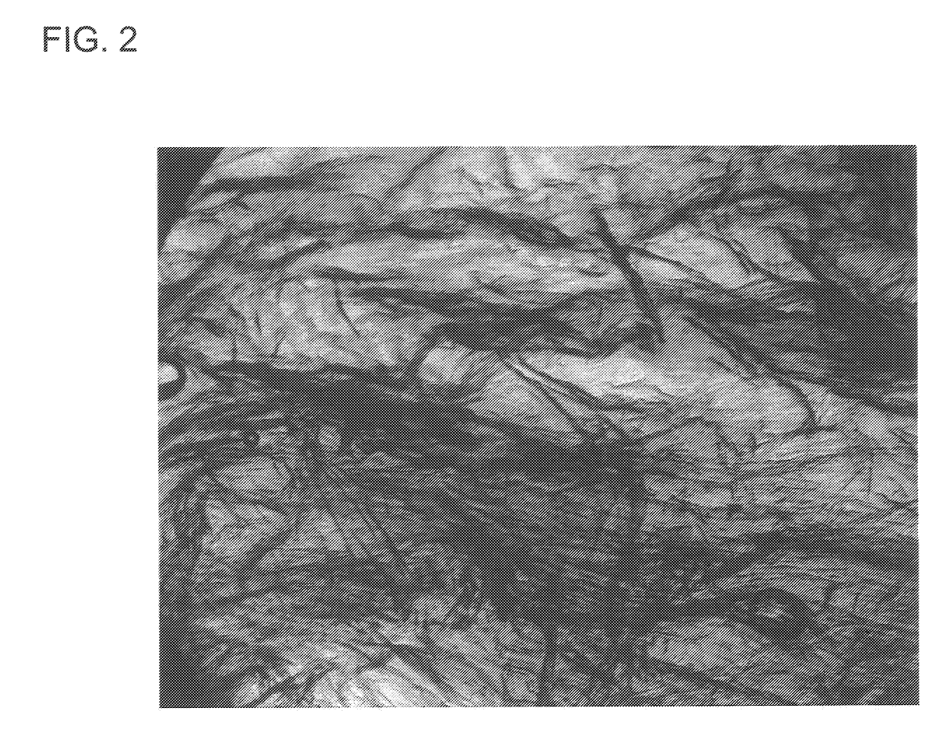

FIG. 2 depicts an image of a micrograph showing a protein product not produced by the process of the present invention. The protein fibers comprising the protein product, as described herein, are crosshatched.

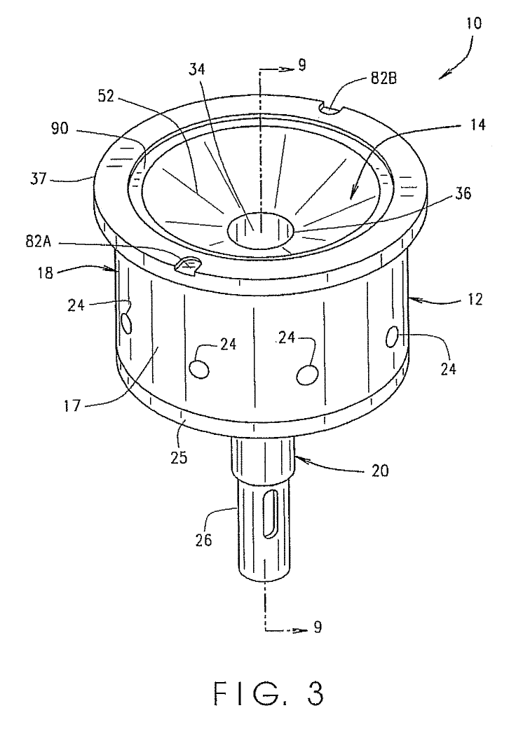

FIG. 3 depicts a perspective view of a peripheral die assembly that may be used in the extrusion process of the protein containing materials.

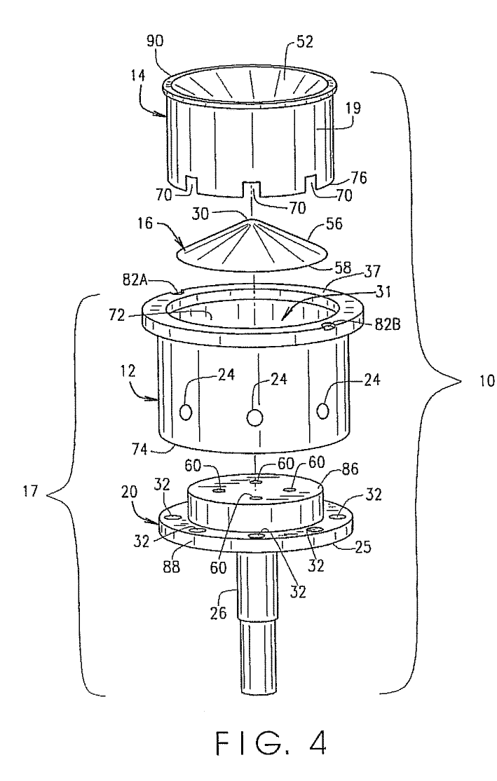

FIG. 4 depicts an exploded view of the peripheral die assembly of FIG. 3 showing the die insert, die sleeve and die cone.

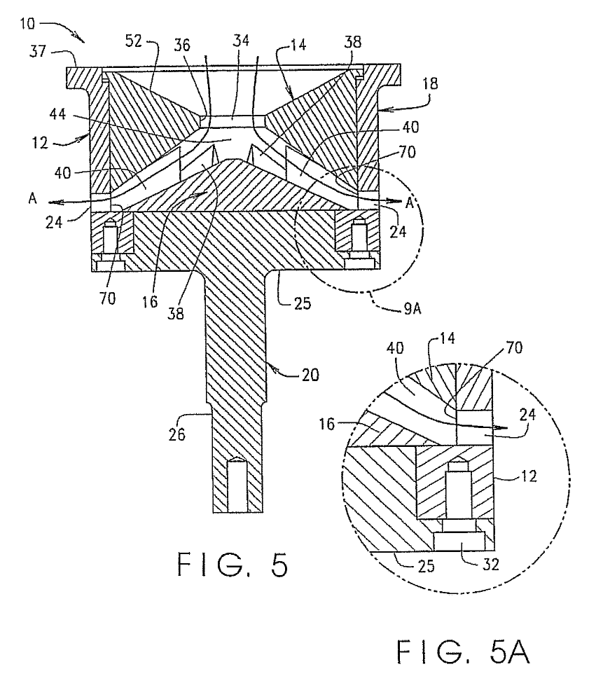

FIG. 5 depicts a cross-sectional view taken along line 9-9 of FIG. 3 showing a flow channel defined between the die sleeve, die insert, and die cone arrangement. FIG. 5A depicts an enlarged cross-sectional view of FIG. 5 showing the interface between the flow channel and the outlet of the die sleeve.

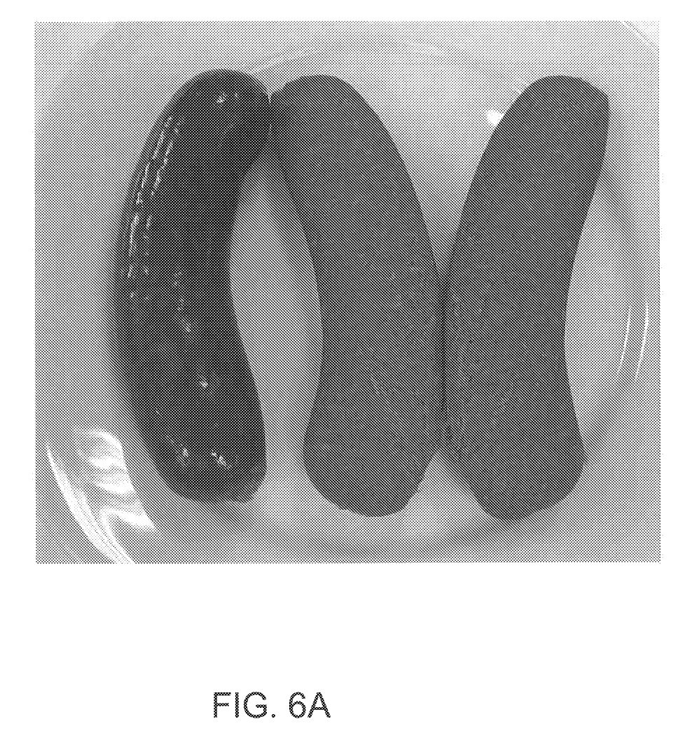

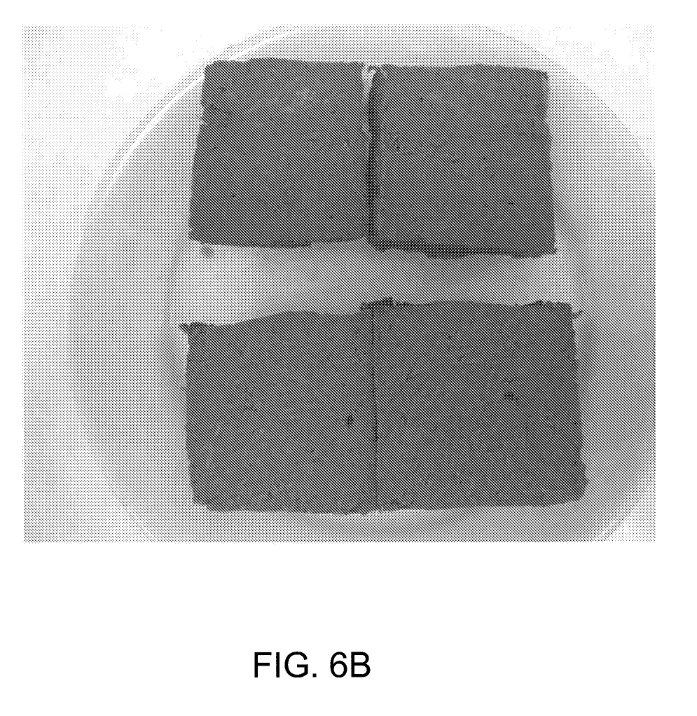

FIG. 6 depicts images of processed animal meat products of the invention. FIG. 6A shows cooked and uncooked sausages. FIG. 6B presents canned luncheon meat products.

### DETAILED DESCRIPTION OF THE INVENTION

The present invention provides processed meat compositions comprising a structured protein product having substantially aligned protein fibers and a reprocessed animal meat product. The reprocessed meat product comprises rework pieces that are leftover during the manufacture of processed meat products. However, it is also possible to use processed meats that are not leftovers. In this invention, the terms “reprocessed” and “reworked” are used interchangeably. The processed meat composition optionally may further comprise uncooked animal meat in the formulation. It has been discovered that a high percentage of processed meat product may be mixed with the structured protein product to make the processed meat composition of the invention. Typically, formulations for processed meat product may include no more than about 10% of rework processed meat products without sacrificing desirable textural properties. In contrast, the processed meat compositions of the invention may comprise up to about 80% of rework processed meat products. Furthermore, food products comprising the processed meat compositions of the invention have improved nutritional profiles and desirable textural characteristics.

### (I) Processed Meat Compositions

The processed meat compositions of the invention comprise a structured protein product having protein fibers that are substantially aligned, as described in more detail in section IA below, and a reprocessed animal meat product, as detailed below in section IB below. Because the structured protein products have protein fibers that are substantially aligned in a manner similar to animal meat, the processed meat compositions of the invention have textural properties similar to those of processed meat compositions formulated from uncooked animal meat, while providing an improved nutritional profile (i.e., higher percentages of protein and lower percentages of fat).

### A Structured Protein Products

The structured protein products have protein fibers that are substantially aligned, as described below. A structured protein product is made by extruding a protein-containing material through a die assembly under conditions of elevated temperature and pressure. A variety of ingredients that contain protein may be used to produce the structured protein products. The protein-containing materials may be derived from plant or animal sources. The plant and animal sources may be grown conventionally or they may be grown organically. Additionally, combinations of protein-containing materials from various sources may be used in combination to produce structured protein products having substantially aligned protein fibers.

### (a) Protein-Containing Materials

As mentioned above, the protein-containing material may be derived from a variety of sources. Irrespective of its source or ingredient classification, the ingredients utilized in the extrusion process are typically capable of forming structured protein products having protein fibers that are substantially aligned. Suitable examples of such ingredients are detailed more fully below.

The amount of protein present in the ingredient(s) can and will vary depending upon the application. For example, the amount of protein present in the ingredient(s) utilized may range from about 40% to about 100% by weight. In another embodiment, the amount of protein present in the ingredient(s) utilized may range from about 50% to about 100% by weight. In an additional embodiment, the amount of protein present in the ingredient(s) utilized may range from about 60% to about 100% by weight. In a further embodiment, the amount of protein present in the ingredient(s) utilized may range from about 70% to about 100% by weight. In still another embodiment, the amount of protein present in the ingredient(s) utilized may range from about 80% to about 100% by weight. In a further embodiment, the amount of protein present in the ingredient(s) utilized may range from about 90% to about 100% by weight.

(i) Plant Protein Materials

In an exemplary embodiment, at least one ingredient derived from a plant will be utilized to form the structured protein product. Generally speaking, the ingredient will comprise a protein. The protein containing material derived from a plant may be a plant extract, a plant meal, a plant-derived flour, a plant protein isolate, a plant protein concentrate, or a combination thereof.

The ingredient(s) utilized in extrusion may be derived from a variety of suitable plants. By way of non-limiting examples, suitable plants include amaranth, arrowroot, barley, buckwheat, cassava, canola, channa (garbanzo), corn, kamut, lentil, lupin, millet, oat, pea, peanut, potato, quinoa, rice, rye, sorghum, sunflower, tapioca, triticale, wheat, and mixtures thereof. Exemplary plants include soy, wheat, canola, corn, lupin, oat, pea, potato, and rice.

In one embodiment, the ingredients may be isolated from wheat and soybeans. In another exemplary embodiment, the ingredients may be isolated from soybeans. In a further embodiment, the ingredients may be isolated from wheat. Suitable wheat derived protein-containing ingredients include wheat gluten, wheat flour, and mixtures thereof. Examples of commercially available wheat gluten that may be utilized in the invention include Manildra Gem of the West Vital Wheat Gluten and Manildra Gem of the West Organic Vital Wheat Gluten each of which is available from Manildra Milling. Suitable soybean derived protein-containing ingredients (“soy protein material”) include soy protein isolate, soy protein concentrate, soy flour, and mixtures thereof, each of which is detailed below.

In an exemplary embodiment, as detailed above, soy protein isolate, soy protein concentrate, soy flour, and mixtures thereof may be utilized in the extrusion process. The soy protein materials may be derived from whole soybeans in accordance with methods generally known in the art. The whole soybeans may be standard soybeans (i.e., non genetically modified soybeans), organic soybeans, commoditized soybeans, or genetically modified soybeans.

In one embodiment, the soy protein material may be a soy protein isolate (ISP). In general, a soy protein isolate has a protein content of at least about 90% soy protein on a moisture-free basis. Generally speaking, when soy protein isolate is used, an isolate is preferably selected that is not a highly hydrolyzed soy protein isolate. In certain embodiments, highly hydrolyzed soy protein isolates, however, may be used in combination with other soy protein isolates provided that the highly hydrolyzed soy protein isolate content of the combined soy protein isolates is generally less than about 40% of the combined soy protein isolates, by weight. Additionally, the soy protein isolate utilized preferably has an emulsion strength and gel strength sufficient to enable the protein in the isolate to form fibers that are substantially aligned upon extrusion. Examples of soy protein isolates that are useful in the present invention are commercially available, for example, from Solae, LLC (St. Louis, Mo.), and include SUPRO® 500E, SUPRO® EX 33, SUPRO® 620, SUPRO® EX 45, and SUPRO® 595. In an exemplary embodiment, a form of SUPRO® 620 is utilized as detailed in Example 3.

In another embodiment, the soy protein material may be a soy protein concentrate, which has a protein content of about 65% to less than about 90% on a moisture-free basis. Alternatively, soy protein concentrate may be blended with the soy protein isolate to substitute for a portion of the soy protein isolate as a source of soy protein material. Typically, if a soy protein concentrate is substituted for a portion of the soy protein isolate, the soy protein concentrate is substituted for up to about 40% of the soy protein isolate by weight, at most, and more preferably is substituted for up to about 30% of the soy protein isolate by weight. Examples of suitable soy protein concentrates useful in the invention include ALPHA™ DSP, Procon 2000, Alpha™ 12 and Alpha™ 5800, which are commercially available from Solae, LLC (St. Louis, Mo.).

In yet another embodiment, the soy protein material may be soy flour, which has a protein content of about 49% to about 65% on a moisture-free basis. Alternatively, soy flour may be blended with soy protein isolate or soy protein concentrate.

(ii) Animal Protein Materials

A variety of animal meats are suitable as a protein source. Animals from which the meat is obtained may be raised conventionally or organically. The meat may be from a farm animal selected from the group consisting of sheep, cattle, goats, pork, bison, and horses. The animal meat may be from poultry, such as chicken or turkey; water fowl, such as duck or goose; game bird, such as pheasant or partridge; or wildfowl, such as guinea fowl or peafowl. Alternatively, the animal meat may be from a game animal. Non-limiting examples of suitable game animals include buffalo, deer, elk, moose, reindeer, caribou, antelope, rabbit, squirrel, beaver, muskrat, opossum, raccoon, armadillo, porcupine, and snake. In a further embodiment, the animal meat may be from fish or seafood. Non-limiting examples of suitable fish include bass, carp, catfish, cobia, cod, grouper, flounder, haddock, hoki, perch, pollock, salmon, snapper, sole, trout, tuna, whitefish, and whiting. Non-limiting examples of seafood include shrimp, lobster, clams, crabs, mussels, and oysters. In an exemplary embodiment, the animal meat is from beef, lamb, pork, chicken, turkey, and combinations thereof.

It is also envisioned that a variety of meat qualities may be utilized in the invention. The meat may comprise muscle tissue, organ tissue, connective tissue and skin. The meat may be any meat suitable for human consumption. The meat may be non-rendered, non-dried, raw meat, raw meat products, raw meat by-products, and mixtures thereof. For example, whole meat muscle that is either ground or in chunk or steak form may be utilized. In another embodiment, the meat may be mechanically deboned or separated raw meats using high-pressure machinery that separates bone from animal tissue, by first crushing bone and adhering animal tissue and then forcing the animal tissue, and not the bone, through a sieve or similar screening device. The process forms an unstructured, paste-like blend of soft animal tissue with a batter-like consistency and is commonly referred to as mechanically deboned meat or MDM. Alternatively, the meat may be a meat by-product. In the context of the present invention, the term “meat by-products” is intended to refer to those non-rendered parts of the carcass of slaughtered animals including but not restricted to mammals, poultry and the like. Examples of meat by-products are organs and tissues such as lungs, spleens, kidneys, brain, liver, blood, bone, partially defatted low-temperature fatty tissues, stomachs, intestines free of their contents, and the like.

The protein source may also be an animal derived protein other than animal tissue. For example, the protein-containing material may be derived from a diary product. Suitable diary protein products include non-fat dried milk powder, milk protein isolate, milk protein concentrate, casein protein isolate, casein protein concentrate, caseinates, whey protein isolate, whey protein concentrate, or combinations thereof. The milk protein-containing material may be derived from cows, goats, sheep, donkeys, camels, camelids, yaks, or water buffalos. In an exemplary embodiment, the dairy protein is whey protein.

By way of further example, a protein-containing material may also be from an egg product. Suitable egg protein products include powdered egg, dried egg solids, dried egg white protein, liquid egg white protein, egg white protein powder, isolated ovalbumin protein, or combinations thereof. Examples of suitable isolated egg proteins include ovalbumin, ovoglobulin, ovomucin, ovomucoid, ovotransferrin, ovovitella, ovovitellin, albumin globulin, and vitellin. Egg protein products may be derived from the eggs of chicken, duck, goose, quail, or other birds.

(iii) Combinations of Protein-Containing Materials

Non-limiting combinations of protein-containing materials isolated from a variety of sources are detailed in Table A. In one embodiment, the protein-containing material is derived from soybeans. In a preferred embodiment, the protein-containing material comprises a mixture of materials derived from soybeans and wheat. In another preferred embodiment, the protein-containing material comprises a mixture of materials derived from soybeans and canola. In still another preferred embodiment, the protein-containing material comprises a mixture of materials derived from soybeans, wheat, and dairy, wherein the dairy protein is whey.

TABLE A
Protein Material Combinations.

| First protein ingredient | Second protein ingredient |
|---|---|
| soybean | wheat |
| soybean | canola |
| soybean | corn |
| soybean | lupin |
| soybean | oat |
| soybean | pea |
| soybean | rice |
| soybean | sorghum |
| soybean | amaranth |
| soybean | arrowroot |
| soybean | barley |
| soybean | buckwheat |
| soybean | cassava |
| soybean | channa (garbanzo) |
| soybean | millet |
| soybean | peanut |
| soybean | potato |
| soybean | rye |
| soybean | sunflower |
| soybean | tapioca |
| soybean | triticale |
| soybean | dairy |
| soybean | whey |
| soybean | egg |
| soybean | wheat and canola |
| soybean | wheat and corn |
| soybean | wheat and lupin |
| soybean | wheat and oat |
| soybean | wheat and pea |
| soybean | wheat and rice |
| soybean | wheat and sorghum |
| soybean | wheat and amaranth |
| soybean | wheat and arrowroot |
| soybean | wheat and barley |
| soybean | wheat and buckwheat |
| soybean | wheat and cassava |
| soybean | wheat and channa (garbanzo) |
| soybean | wheat and millet |
| soybean | wheat and peanut |
| soybean | wheat and rye |
| soybean | wheat and potato |
| soybean | wheat and sunflower |
| soybean | wheat and tapioca |
| soybean | wheat and triticale |
| soybean | wheat and dairy |
| soybean | wheat and whey |
| soybean | wheat and egg |
| soybean | canola and corn |
| soybean | canola and lupin |
| soybean | canola and oat |
| soybean | canola and pea |
| soybean | canola and rice |
| soybean | canola and sorghum |
| soybean | canola and amaranth |
| soybean | canola and arrowroot |
| soybean | canola and barley |
| soybean | canola and buckwheat |
| soybean | canola and cassava |
| soybean | canola and channa (garbanzo) |
| soybean | canola and millet |
| soybean | canola and peanut |
| soybean | canola and rye |
| soybean | canola and potato |
| soybean | canola and sunflower |
| soybean | canola and tapioca |
| soybean | canola and triticale |
| soybean | canola and dairy |
| soybean | canola and whey |
| soybean | canola and egg |
| soybean | corn and lupin |
| soybean | corn and oat |
| soybean | corn and pea |
| soybean | corn and rice |
| soybean | corn and sorghum |
| soybean | corn and amaranth |
| soybean | corn and arrowroot |
| soybean | corn and barley |
| soybean | corn and buckwheat |
| soybean | corn and cassava |
| soybean | corn and channa (garbanzo) |
| soybean | corn and millet |
| soybean | corn and peanut |
| soybean | corn and rye |
| soybean | corn and potato |
| soybean | corn and sunflower |
| soybean | corn and tapioca |
| soybean | corn and triticale |
| soybean | corn and dairy |
| soybean | corn and whey |
| soybean | corn and egg |

### (b) Additional Ingredients

(i) Carbohydrates

It is envisioned that other ingredient additives in addition to proteins may be utilized in the structured protein products. Non-limiting examples of such ingredients include sugars, starches, oligosaccharides, and dietary fibers. As an example, starches may be derived from wheat, corn, tapioca, potato, rice, and the like. A suitable fiber source may be soy cotyledon fiber. Typically, suitable soy cotyledon fiber will generally effectively bind water when the mixture of soy protein and soy cotyledon fiber is co-extruded. In this context, “effectively bind water” generally means that the soy cotyledon fiber has a water holding capacity of at least 5.0 to about 8.0 grams of water per gram of soy cotyledon fiber, and preferably the soy cotyledon fiber has a water holding capacity of at least about 6.0 to about 8.0 grams of water per gram of soy cotyledon fiber. Soy cotyledon fiber may generally be present in the soy protein-containing material in an amount ranging from about 1% to about 20%, preferably from about 1.5% to about 20% and most preferably, at from about 2% to about 5% by weight on a moisture free basis. Suitable soy cotyledon fiber is commercially available. For example, FIBRIM® 1260 and FIBRIM® 2000 are soy cotyledon fiber materials that are commercially available from Solae, LLC (St. Louis, Mo.).

In each of the embodiments delineated in Table A, the combination of protein-containing materials may be combined with one or more ingredients selected from the group consisting of a starch, flour, gluten, dietary fiber, and mixtures thereof. In one embodiment, the protein-containing material comprises protein, starch, gluten, and fiber. In an exemplary embodiment, the protein-containing material comprises from about 45% to about 65% soy protein on a dry matter basis; from about 20% to about 30% wheat gluten on a dry matter basis; from about 10% to about 15% wheat starch on a dry matter basis; and from about 1% to about 5% fiber on a dry matter basis. In each of the foregoing embodiments, the protein-containing material may further comprise dicalcium phosphate, L-cysteine, or combinations of both dicalcium phosphate and L-cysteine.

(ii) Optional pH-Lowering Agent

In some embodiments, it may be desirable to lower the pH of the protein-containing material to an acidic pH (i.e., below approximately 7.0). Thus, the protein-containing material may be contacted with a pH-lowering agent, and the mixture is then extruded according to the process detailed below. In one embodiment, the pH of the protein-containing material to be extruded may range from about 6.0 to about 7.0. In another embodiment, the pH may range from about 5.0 to about 6.0. In an alternate embodiment, the pH may range from about 4.0 to about 5.0. In yet another embodiment, the pH of the material may be less than about 4.0.

Several pH-lowering agents are suitable for use in the invention. The pH-lowering agent may be organic. Alternatively, the pH-lowering agent may be inorganic. In exemplary embodiments, the pH-lowering agent is a food grade edible acid. Non-limiting acids suitable for use in the invention include acetic, lactic, hydrochloric, phosphoric, citric, tartaric, malic, and combinations thereof. In an exemplary embodiment, the pH-lowering agent is lactic acid.

As will be appreciated by a skilled artisan, the amount of pH-lowering agent contacted with the protein-containing material can and will vary depending upon several parameters, including, the agent selected and the desired pH. In one embodiment, the amount of pH-lowering agent may range from about 0.1% to about 15% on a dry matter basis. In another embodiment, the amount of pH-lowering agent may range from about 0.5% to about 10% on a dry matter basis. In an alternate embodiment, the amount of pH-lowering agent may range from about 1% to about 5% on a dry matter basis. In still another embodiment, the amount of pH-lowering agent may range from about 2% to about 3% on a dry matter basis.

(iii) Optional Antioxidants

One or more antioxidants may be added to any of the combinations of protein-containing materials mentioned above without departing from the scope of the invention. Preservatives that may be added include sodium lactate and sodium diacetate. Antioxidants may be included to increase the shelf-life or nutritionally enhance the structured protein products. Non-limiting examples of suitable antioxidants include BHA, BHT, TBHQ, vitamins A, C and E and derivatives, and various plant extracts, such as those containing carotenoids, tocopherols or flavonoids having antioxidant properties. The preservative and antioxidants may have a combined presence at levels of from about 0.01% to about 10%, preferably, from about 0.05% to about 5%, and more preferably from about 0.1% to about 2%, by weight of the protein-containing materials that will be extruded.

(iv) Optional Minerals and Amino Acids

The protein-containing material may also optionally comprise supplemental minerals. Suitable minerals may include one or more minerals or mineral sources. Non-limiting examples of minerals include, without limitation, chloride, sodium, calcium, iron, chromium, copper, iodine, zinc, magnesium, manganese, molybdenum, phosphorus, potassium, and selenium. Suitable forms of any of the foregoing minerals include soluble mineral salts, slightly soluble mineral salts, insoluble mineral salts, chelated minerals, mineral complexes, non-reactive minerals such as carbonyl minerals, and reduced minerals, and combinations thereof.

Free amino acids may also be included in the protein-containing material. Suitable amino acids include the essential amino acids, i.e., arginine, cysteine, histidine, isoleucine, leucine, lysine, methionine, phenylalanine, threonine, tryptophan, and valine. Suitable forms of the amino acids include salts and chelates.

(v) Optional Colorants

The protein-containing material may also be contacted with at least one colorant. The colorant(s) may be mixed with the protein-containing material and other ingredients prior to being fed into the extruder. Alternatively, the colorant(s) may be combined with the protein-containing material and other ingredients after being fed into the extruder.

The colorant(s) may be a natural colorant, a combination of natural colorants, an artificial colorant, a combination of artificial colorants, or a combination of natural and artificial colorants. Suitable examples of natural colorants approved for use in food include annatto (reddish-orange), anthocyanins (red to blue, depends upon pH), beet juice, beta-carotene (orange), beta-APO 8 carotenal (orange), black currant, burnt sugar; canthaxanthin (pink-red), caramel, carmine/carminic acid (bright red), cochineal extract (red), curcumin (yellow-orange); lac (scarlet red), lutein (red-orange); lycopene (orange-red), mixed carotenoids (orange), monascus (red-purple, from fermented red rice), paprika, red cabbage juice, riboflavin (yellow), saffron, titanium dioxide (white), and turmeric (yellow-orange). Suitable examples of artificial colorants approved for food use in the United States include FD&C Red No. 3 (Erythrosine), FD&C Red No. 40 (Allure Red), FD&C Yellow No. 5 (Tartrazine), FD&C Yellow No. 6 (Sunset Yellow FCF), FD&C Blue No. 1 (Brilliant Blue), FD&C Blue No. 2 (Indigotine). Artificial colorants that may be used in other countries include C1 Food Red 3 (Carmoisine), C1 Food Red 7 (Ponceau 4R), C1 Food Red 9 (Amaranth), C1 Food Yellow 13 (Quinoline Yellow), and C1 Food Blue 5 (Patent Blue V). Food colorants may be dyes, which are powders, granules, or liquids that are soluble in water. Alternatively, natural and artificial food colorants may be lake colors, which are combinations of dyes and insoluble materials. Lake colors are not oil soluble, but are oil dispersible; they tint by dispersion.

Suitable colorant(s) may be combined with the protein-containing materials in a variety of forms. Non-limiting examples include solid, semi-solid, powdered, liquid, and gelatin. The type and concentration of colorant(s) utilized may vary depending on the protein-containing materials used and the desired color of the colored structured protein product. Typically, the concentration of colorant(s) may range from about 0.001% to about 5.0% by weight. In one embodiment, the concentration of colorant(s) may range from about 0.01% to about 4.0% by weight. In another embodiment, the concentration of colorant(s) may range from about 0.05% to about 3.0% by weight. In still another embodiment, the concentration of colorant(s) may range from about 0.1% to about 3.0% by weight. In a further embodiment, the concentration of colorant(s) may range from about 0.5% to about 2.0% by weight. In another embodiment, the concentration of colorant(s) may range from about 0.75% to about 1.0% by weight.

The protein-containing material may further comprise an acidity regulator to maintain the pH in the optimal range for the colorant(s) utilized. The acidity regulator may be an acidulent. Examples of acidulents that may be added include citric acid, acetic acid (vinegar), tartaric acid, malic acid, fumaric acid, lactic acid, phosphoric acid, sorbic acid, and benzoic acid. The concentration of the acidity regulator utilized may vary depending on the protein-containing materials and the colorant used. Typically, the concentration of acidity regulator may range from about 0.001% to about 5.0% by weight. In one embodiment, the concentration of acidity regulator may range from about 0.01% to about 4.0% by weight. In another embodiment, the concentration of acidity regulator may range from about 0.05% to about 3.0% by weight. In still another embodiment, the concentration of acidity regulator may range from about 0.1% to about 3.0% by weight. In a further embodiment, the concentration of acidity regulator may range from about 0.5% to about 2.0% by weight. In another embodiment, the concentration of acidity regulator may range from about 0.75% to about 1.0% by weight. In an alternative embodiment, the acidity regulator may be a pH-raising agent, such as disodium diphosphate.

### (c) Making the Structured Protein Product

The structured protein products are made by extruding protein-containing material through a die assembly under conditions of elevated temperature and pressure. After extrusion, the resulting structured protein product comprises protein fibers that are substantially aligned.

As will be appreciated by the skilled artisan, the moisture content of the protein-containing materials and optional additional ingredients can and will vary depending on the thermal process the combination is subjected to e.g. retort cooking, microwave cooking, and extrusion. Generally speaking in extrusion applications, the moisture content may range from about 1% to about 80% by weight. In low moisture extrusion applications, the moisture content of the protein-containing materials may range from about 1% to about 35% by weight. Alternatively, in high moisture extrusion applications, the moisture content of the protein-containing materials may range from about 35% to about 80% by weight. In an exemplary embodiment, the extrusion application utilized to form the extrudates is low moisture. An exemplary example of a low moisture extrusion process to produce extrudates having proteins with fibers that are substantially aligned is detailed below in Example 3.

A suitable extrusion process for the preparation of a structured protein product comprises introducing the protein-containing material which includes plant protein material and optionally other protein material, and other ingredients into a mixing tank (i.e., an ingredient blender) to combine the ingredients and form a blended protein material pre-mix. The blended protein material pre-mix may then be transferred to a hopper from which the blended ingredients may be introduced along with moisture into a pre-conditioner to form a conditioned protein material mixture. In another embodiment, the blended protein material pre-mix may be combined with a conditioner to form a conditioned protein material mixture. The conditioned material may then be fed into an extruder in which the protein material mixture is heated under mechanical pressure generated by the screws of the extruder to form a colored molten extrusion mass. Alternatively, the dry blended protein material pre-mix may be directly fed to an extruder in which moisture and heat are introduced to from a molten extrusion mass. The molten extrudate exits the extruder through an extrusion die forming an extrudate comprising structured protein fibers that are substantially aligned.

Among the suitable extrusion apparatuses useful in the practice of the present invention is a double barrel, twin-screw extruder as described, for example, in U.S. Pat. No. 4,600,311. Further examples of suitable commercially available extrusion apparatuses include a CLEXTRAL® Model BC-72 extruder manufactured by Clextral, Inc. (Tampa, Fla.); a WENGER Model TX-57 extruder, a WENGER Model TX-168 extruder, and a WENGER Model TX-52 extruder all manufactured by Wenger Manufacturing, Inc. (Sabetha, Kans.). Other conventional extruders suitable for use in this invention are described, for example, in U.S. Pat. Nos. 4,763,569, 4,118,164, and 3,117,006, which are hereby incorporated by reference in their entirety.

A single-screw extruder could also be used in the present invention. Examples of suitable, commercially available single-screw extrusion apparatuses include the WENGER Model X-175, the WENGER Model X-165, and the WENGER Model X-85, all of which are available from Wenger Manufacturing, Inc.

The screws of a twin-screw extruder can rotate within the barrel in the same or opposite directions. Rotation of the screws in the same direction is referred to as single flow whereas rotation of the screws in opposite directions is referred to as double flow. The speed of the screw or screws of the extruder may vary depending on the particular apparatus; however, it is typically from about 250 to about 350 revolutions per minute (rpm). Generally, as the screw speed increases, the density of the extrudate will decrease. The extrusion apparatus contains screws assembled from shafts and worm segments, as well as mixing lobe and ring-type shearlock elements as recommended by the extrusion apparatus manufacturer for extruding protein-containing material.

The extrusion apparatus generally comprises a plurality of heating zones through which the protein mixture is conveyed under mechanical pressure prior to exiting the extrusion apparatus through an extrusion die assembly. The temperature in each successive heating zone generally exceeds the temperature of the previous heating zone by between about 10° C. and about 70° C. In one embodiment, the conditioned pre-mix is transferred through four heating zones within the extrusion apparatus, with the protein mixture heated to a temperature of from about 100° C. to about 150° C. such that the molten extrusion mass enters the extrusion die assembly at a temperature of from about 100° C. to about 150° C. One skilled in the art could adjust the temperature either heating or cooling to achieve the desired properties. Typically, temperature changes are due to work input and can happen suddenly.

The pressure within the extruder barrel is typically between about 50 psig to about 500 psig preferably between about 75 psig to about 200 psig. Generally, the pressure within the last two heating zones is from about 100 psig to about 3000 psig preferably between about 150 psig to about 500 psig. The barrel pressure is dependent on numerous factors including, for example, the extruder screw speed, feed rate of the mixture to the barrel, feed rate of water to the barrel, and the viscosity of the molten mass within the barrel.

Water may be injected into the extruder barrel to hydrate the protein material mixture and promote texturization of the proteins. As an aid in forming the molten extrusion mass, the water may act as a plasticizing agent. Water may be introduced to the extruder barrel via one or more injection jets in communication with a heating zone. Optionally, the water may be combined with at least one colorant and injected into the extruder barrel. In one embodiment, the combined water and colorant(s) may be injected into the extruder barrel. Typically, the mixture in the barrel contains from about 15% to about 35% by weight water. In one embodiment, the mixture in the barrel contains from about 5% to about 20% by weight water. The rate of introduction of water to any of the heating zones is generally controlled to promote production of an extrudate having desired characteristics. It has been observed that as the rate of introduction of water to the barrel decreases, the density of the extrudate decreases. Typically, less than about 1 kg of water per kg of protein is introduced to the barrel. Preferably, from about 0.1 kg to about 1 kg of water per kg of protein are introduced to the barrel.

The premix may optionally be preconditioned. In a pre-conditioner, the protein-containing material and optional additional ingredients (protein-containing mixture) are preheated, contacted with moisture, and held under controlled temperature and pressure conditions to allow the moisture to penetrate and soften the individual particles. In one embodiment, the protein-containing material and optional additional ingredients may be combined with at least one colorant. The preconditioning step increases the bulk density of the particulate fibrous material mixture and improves its flow characteristics. The preconditioner contains one or more paddles to promote uniform mixing of the protein and transfer of the protein mixture through the preconditioner. The configuration and rotational speed of the paddles vary widely, depending on the capacity of the preconditioner, the extruder throughput and/or the desired residence time of the mixture in the preconditioner or extruder barrel. Generally, the speed of the paddles is from about 100 to about 1300 revolutions per minute (rpm). Agitation must be high enough t to obtain even hydration and good mixing.

The protein-containing mixture may be pre-conditioned prior to introduction into the extrusion apparatus by contacting the pre-mix with moisture (i.e., steam and/or water). In one embodiment, the pre-mix may be combined with moisture and at least one colorant. Preferably the protein-containing mixture is heated to a temperature of from about 25° C. to about 80° C., more preferably from about 30° C. to about 40° C. in the preconditioner.

Typically, the protein-containing pre-mix is conditioned for a period of about 30 to about 60 seconds, depending on the speed and the size of the pre-conditioner. In an exemplary embodiment, the protein-containing pre-mix is conditioned for a period of about 3.0 minutes to about 5.0 minutes. The pre-mix is contacted with steam and/or water and heated in the pre-conditioner at generally constant steam flow to achieve the desired temperatures. The water and/or steam conditions (i.e., hydrates) the pre-mix, increases its density, and facilitates the flowability of the dried mix without interference prior to introduction to the extruder barrel where the proteins are texturized. If low moisture pre-mix is desired, the conditioned pre-mix may contain from about 1% to about 35% (by weight) water. If high moisture pre-mix is desired, the conditioned pre-mix may contain from about 35% to about 80% (by weight) water.

The conditioned pre-mix typically has a bulk density of from about 0.25 g/cm³ to about 0.60 g/cm³. Generally, as the bulk density of the pre-conditioned protein mixture increases within this range, the protein mixture is easier to process. This is presently believed to be due to such mixtures occupying all or a majority of the space between the screws of the extruder, thereby facilitating conveying the extrusion mass through the barrel.

Whatever extruder is used, it should be run in excess of about 50% motor load. The rate at which the pre-mix is generally introduced to the extrusion apparatus will vary depending upon the particular apparatus. Typically, the conditioned pre-mix is introduced to the extrusion apparatus at a rate of between about 16 kilograms per minute to about 60 kilograms per minute. In another embodiment, the conditioned pre-mix is introduced to the extrusion apparatus at a rate between 20 kilograms per minute to about 40 kilograms per minute. The conditioned pre-mix is introduced to the extrusion apparatus at a rate of between about 26 kilograms per minute to about 32 kilograms per minute. Generally, it has been observed that the density of the extrudate decreases as the feed rate of pre-mix to the extruder increases.

The pre-mix is subjected to shear and pressure by the extruder to plasticize the mixture. The screw elements of the extruder shear the mixture as well as create pressure in the extruder by forcing the mixture forwards though the extruder and through the die assembly. The screw motor speed determines the amount of shear and pressure applied to the mixture by the screw(s). Preferably, the screw motor speed is set to a speed of from about 200 rpm to about 500 rpm, and more preferably from about 300 rpm to about 450 rpm, which moves the mixture through the extruder at a rate of at least about 20 kilograms per hour, and more preferably at least about 40 kilograms per hour. Preferably the extruder generates an extruder barrel exit pressure of from about 50 to about 3000 psig, and more preferably an extruder barrel exit pressure of from about 600 to about 1000 psig is generated.

The extruder controls the temperature of the mixture as it passes through the extruder denaturing the protein in the mixture. The extruder includes a means for heating the mixture to temperatures of from about 100° C. to about 180° C. Preferably the means for heating the mixture in the extruder comprises extruder barrel jackets into which heating or cooling media such as steam or water may be introduced to control the temperature of the mixture passing through the extruder. The extruder also includes steam injection ports for directly injecting steam into the mixture within the extruder. The extruder may also include colorant injection ports for directly injecting colorant into the mixture within the extruder. The extruder preferably includes multiple heating zones that can be controlled to independent temperatures, where the temperatures of the heating zones are preferably set to increase the temperature of the mixture as it proceeds through the extruder. In one embodiment, the extruder may be set in a four temperature zone arrangement, where the first zone (adjacent the extruder inlet port) is set to a temperature of from about 80° C. to about 100° C., the second zone is set to a temperature of from about 100° C. to 135° C., the third zone is set to a temperature of from 135° C. to about 150° C., and the fourth zone (adjacent the extruder exit port) is set to a temperature of from 150° C. to 180° C. The extruder may be set in other temperature zone arrangements, as desired. In another embodiment, the extruder may be set in a five temperature zone arrangement, where the first zone is set to a temperature of about 25° C., the second zone is set to a temperature of about 50° C., the third zone is set to a temperature of about 95° C., the fourth zone is set to a temperature of about 130° C., and the fifth zone is set to a temperature of about 150° C.

The mixture forms a melted colored plasticized mass in the extruder. A die assembly is attached to the extruder in an arrangement that permits the colored plasticized mixture to flow from the extruder exit port into the die assembly and produces substantial alignment of the protein fibers within the colored plasticized mixture as it flows through the die assembly. The die assembly may include either a faceplate die or a peripheral die.

One embodiment includes a peripheral die assembly as illustrated and generally indicated as 10 in FIGS. 3-5.

As shown in FIGS. 3 and 4, the peripheral die assembly 10 may include a die sleeve 12 having a cylindrical-shaped two-part sleeve die body 17. The sleeve die body 17 may include a rear portion 18 coupled to a front portion 20 that collectively define an internal chamber 31 in communication with opposing openings 72, 74. The die sleeve 12 may be adapted to receive a die insert 14 and a die cone 16 for providing the necessary structural elements to facilitate laminar flow of the plasticized mixture through the peripheral die assembly 10 during the extrusion process.

Additionally, the front portion 20 of the die sleeve 12 may be secured to a die cone 16 adapted to interface with the die insert 14 when the front portion 20 is secured to the rear portion 18 of the die sleeve 12 during assembly of the peripheral die assembly 10. As further shown, the rear portion 18 of die sleeve 12 defines a plurality of circular-shaped outlets 24 along the sleeve body 17 which are adapted to provide a conduit for the egress of the extrudate from the peripheral die assembly 10 during the extrusion process. In the alternative, the plurality of outlets 24 may have different configurations, such as square, rectangular, scalloped or irregular. As further shown, the rear portion 18 of the die sleeve 12 may include a circular flange 37 that surrounds opening 72 and defines a pair of opposing slots 82A and 82B that are used to properly align the die sleeve 12 when engaging the die sleeve 12 to the extruder.

As shown in FIG. 5, when the peripheral die assembly 10 is fully assembled the die insert 14 is disposed within the rear portion 18 of the die sleeve 12 which is secured to the front portion 20 of the die sleeve 12 such that the conical side 56 of the die cone 16 is oriented toward the chamber 31 and encased between the rear and front portions 18 and 20. In this orientation, the conical side 56 is operatively associated with the front face 27 of the die insert 14. As such, the opposing side walls 50 of each adjacent flow diverter 38, the bottom portion 64 of the die insert 14, and the conical side 56 of the die cone 16 collectively define a respective flow channel 40 in communication with a respective outlet 24. The flow channel 40 defined between the die sleeve 12, die insert 14 and die cone 16 as described above may be tapered on all four sides of the flow channel 40. Accordingly, the flow channel 40 gradually tapers inwardly on all four sides from the entrance 84 to the outlet 24 of each flow channel 40.

Referring to FIG. 5A, an enlarged view illustrating the flow pathway “A” through flow channel 40 is shown. Specifically, flow channel 40 communicates with the outlet 24 through opening 70 defined by the die insert 14.

During the extrusion process, the peripheral die assembly 10 is operatively engaged with the extruder and produces a plasticized mixture that contacts the well 52 defined by the rear face 29 of the die insert 14 and flows into the throat 34 and enters the inner space opening 36 as indicated by flow path “A”. The plasticized mixture may enter the inner space 44 defined by the die insert 14 and enter the entrance 84 of each tapered flow channel 42. The plasticized mixture then flows through each flow channel 42 and exits from a respective outlet 24 in a manner that causes the substantial alignment of the protein fibers in the extrudate produced by the peripheral die assembly 10.

The width and height dimensions of the outlet(s) 24 are selected and set prior to extrusion of the mixture to provide the fibrous material extrudate with the desired dimensions. The width of the outlet(s) 24 may be set so that the extrudate resembles from a cubic chunk of meat to a steak filet, where widening the width of the outlet(s) 24 decreases the cubic chunk-like nature of the extrudate and increases the filet-like nature of the extrudate. In an exemplary embodiment, the width of the outlet(s) 24 may be set to a width of from about 5 millimeters to about 40 millimeters.

The height dimension of the outlet(s) 24 may be set to provide the desired thickness of the extrudate. The height of the outlet(s) 24 may be set to provide a very thin extrudate or a thick extrudate. For example, the height of the outlet(s) 24 may be set to from about 1 millimeter to about 30 millimeters. In an exemplary embodiment, the height of the outlet(s) 24 may be set to from about 8 millimeters to about 16 millimeters.

It is also contemplated that the outlet(s) 24 may be round. The diameter of the outlet(s) 24 may be set to provide the desired thickness of the extrudate. The diameter of the outlet(s) 24 may be set to provide a very thin extrudate or a thick extrudate. For example, the diameter of the outlet(s) 24 may be set to from about 1 millimeter to about 30 millimeters. In an exemplary embodiment, the diameter of the outlet(s) 24 may be set to from about 8 millimeters to about 16 millimeters.

Other peripheral die assemblies suitable for use in this invention are described in U.S. Patent App. No. 60/882,662, which is hereby incorporated by reference in its entirety.

The extrudate may be cut after exiting the die assembly. Suitable apparatuses for cutting the extrudate include flexible knives manufactured by Wenger Manufacturing, Inc. (Sabetha, Kans.) and Clextral, Inc. (Tampa, Fla.). Typically, the speed of the cutting apparatus is from about 1000 rpm to about 2500 rpm. In an exemplary embodiment, the speed of the cutting apparatus is about 1600 rpm.

The extrudate may further be comminuted to reduce the average particle size of the extrudate. Typically, the reduced extrudate has an average particle size of from about 0.1 mm to about 40.0 mm. In one embodiment, the reduced extrudate has an average particle size of from about 5.0 mm to about 30.0 mm. In another embodiment, the reduced extrudate has an average particle size of from about 0.5 mm to about 20.0 mm. In a further embodiment, the reduced extrudate has an average particle size of from about 0.5 mm to about 15.0 mm. In an additional embodiment, the reduced extrudate has an average particle size of from about 0.75 mm to about 10.0 mm. In yet another embodiment, the reduced extrudate has an average particle size of from about 1.0 mm to about 5.0 mm. Suitable apparatus for reducing particle size include hammer mills, such as Mikro Hammer Mills manufactured by Hosokawa Micron Ltd., Fitz Mill manufactured by She Hui Machinery Co., Ltd., and Comitrols, such as those manufactured by Urschel Laboratories, Inc.

A dryer, if one is used, generally comprises a plurality of drying zones in which the air temperature may vary. Examples known in the art include convection dryers. The extrudate will be present in the dryer for a time sufficient to produce an extrudate having the desired moisture content. Thus, the temperature of the air is not important; if a lower temperature is used (such as 50° C.) longer drying times will be required than if a higher temperature is used. Generally, the temperature of the air within one or more of the zones will be from about 100° C. to about 185° C. Typically, the extrudate is present in the dryer for a time sufficient to provide an extrudate having the desired moisture content. Generally, the extrudate is dried for at least about 45 minutes and more generally, for at least about 65 minutes. Alternatively, the extrudate may be dried at lower temperatures, such as about 70° C., for longer periods of time. Suitable dryers include those manufactured by CPM Wolverine Proctor (Lexington, NC), National Drying Machinery Co. (Philadelphia, Pa.), Wenger (Sabetha, Kans.), Clextral (Tampa, Fla.), and Buehler (Lake Bluff, Ill.).

Another option is to use microwave assisted drying. In this embodiment, a combination of convective and microwave heating is used to dry the product to the desired moisture. Microwave assisted drying is accomplished by simultaneously using forced-air convective heating and drying to the surface of the product while at the same time exposing the product to microwave heating that forces the moisture that remains in the product to the surface whereby the convective heating and drying continues to dry the product. The convective dryer parameters are the same as discussed previously. The addition is the microwave-heating element, with the power of the microwave being adjusted dependent on the product to be dried as well as the desired final product moisture. As an example the product can be conveyed through an oven that contains a tunnel that is equipped with wave-guides to feed the microwave energy to the product and chokes designed to prevent the microwaves from leaving the oven. As the product is conveyed through the tunnel the convective and microwave heating simultaneously work to lower the moisture content of the product whereby drying. Typically, the air temperature is 50° C. to about 80° C., and the microwave power is varied dependent on the product, the time the oven is in the oven, and the final moisture content desired.

The desired moisture content may vary widely depending on the intended application of the extrudate. Generally speaking, the extruded material has a moisture content of from about 5% to about 11% by weight, if dried, and needs to be hydrated in water until the water is absorbed and the fibers are separated. If the protein material is not dried or not fully dried, its moisture content is higher, generally from about 16% to about 30% by weight. If a protein material with high moisture content is produced, the protein material may require immediate use or refrigeration to ensure product freshness, and minimize spoilage.

The dried extrudate may further be comminuted to reduce the average particle size of the extrudate. Typically, the reduced dried extrudate has an average particle size of from about 0.1 mm to about 40.0 mm. In one embodiment, the reduced dried extrudate has an average particle size of from about 5.0 mm to about 30.0 mm. In another embodiment, the reduced dried extrudate has an average particle size of from about 0.5 mm to about 20.0 mm. In a further embodiment, the reduced dried extrudate has an average particle size of from about 0.5 mm to about 15.0 mm. In an additional embodiment, the reduced dried extrudate has an average particle size of from about 0.75 mm to about 10.0 mm. In yet another embodiment, the reduced dried extrudate has an average particle size of from about 1.0 mm to about 5.0 mm. Suitable apparatus for reducing particle size include hammer mills, such as Mikro Hammer Mills manufactured by Hosokawa Micron Ltd., Fitz Mill manufactured by She Hui Machinery Co., Ltd., and Comitrols, such as those manufactured by Urschel Laboratories, Inc.

(d) Characteristics of the Structured Protein Products

The extrudates produced above typically comprise the structured protein products having protein fibers that are substantially aligned. In the context of this invention “substantially aligned” generally refers to the arrangement of protein fibers such that a significantly high percentage of the protein fibers forming the structured protein product are contiguous to each other at less than approximately a 45° angle when viewed in a horizontal plane. Typically, an average of at least 55% of the protein fibers comprising the structured protein product are substantially aligned. In another embodiment, an average of at least 60% of the protein fibers comprising the structured protein product are substantially aligned. In a further embodiment, an average of at least 60% of the protein fibers comprising the structured protein product are substantially aligned. In an additional embodiment, an average of at least 80% of the protein fibers comprising the structured protein product are substantially aligned. In yet another embodiment, an average of at least 90% of the protein fibers comprising the structured protein product are substantially aligned.

Methods for determining the degree of protein fiber alignment are known in the art and include visual determinations based upon micrographic images. By way of example, FIGS. 1 and 2 depict micrographic images that illustrate the difference between a structured protein product having substantially aligned protein fibers compared to a protein product having protein fibers that are significantly crosshatched. FIG. 1 depicts a structured protein product prepared according to section IAc in which the protein fibers are substantially aligned. Contrastingly, FIG. 2 depicts a protein product containing protein fibers that are significantly crosshatched and not substantially aligned. Because the protein fibers are substantially aligned, as shown in FIG. 1, the structured protein products utilized in the invention generally have the texture and consistency of cooked muscle meat. The structured protein products have the general characteristic of texturized muscle meat. In contrast, traditional extrudates having protein fibers that are randomly oriented or crosshatched generally have a texture that is soft or spongy.

In certain embodiments where the protein material is co-extruded with a reducing sugar, a Maillard reaction may occur, and the resulting structured protein products generally have a dark color. Depending upon the reaction conditions, the color can be optimized to match the color of a desired ground animal meat product. In some embodiments, the color may be a shade of brown, e.g., light brown, medium brown, and dark brown. In other embodiments, the color may be a shade of tan, e.g., light tan, medium tan, and dark tan.

In addition to having protein fibers that are substantially aligned, the structured protein products also typically have shear strength substantially similar to whole meat muscle. In this context of the invention, the term “shear strength” provides one means to quantify the formation of a sufficient fibrous network to impart whole-muscle like texture and appearance to the structured protein product. Shear strength is the maximum force in grams needed to puncture through a given sample. A method for measuring shear strength is described in Example 1. Generally speaking, the structured protein products of the invention will have average shear strength of at least 1400 grams. In an additional embodiment, the structured protein products will have average shear strength of from about 1500 to about 1800 grams. In yet another embodiment, the structured protein products will have average shear strength of from about 1800 to about 2000 grams. In a further embodiment, the structured protein products will have average shear strength of from about 2000 to about 2600 grams. In an additional embodiment, the structured protein products will have average shear strength of at least 2200 grams. In a further embodiment, the structured protein products will have average shear strength of at least 2300 grams. In yet another embodiment, the structured protein products will have average shear strength of at least 2400 grams. In still another embodiment, the structured protein products will have average shear strength of at least 2500 grams. In a further embodiment, the structured protein products will have average shear strength of at least 2600 grams.

A means to quantify the size of the protein fibers formed in the structured protein products may be done by a shred characterization test. Shred characterization is a test that generally determines the percentage of large pieces formed in the structured protein product. In an indirect manner, percentage of shred characterization provides an additional means to quantify the degree of protein fiber alignment in a structured protein product. Generally speaking, as the percentage of large pieces increases, the degree of protein fibers that are aligned within a structured protein product also typically increases. Conversely, as the percentage of large pieces decreases, the degree of protein fibers that are aligned within a structured protein product also typically decreases. A method for determining shred characterization is detailed in Example 2. The structured protein products of the invention typically have an average shred characterization of at least 10% by weight of large pieces. In a further embodiment, the structured protein products have an average shred characterization of from about 10% to about 15% by weight of large pieces. In another embodiment, the structured protein products have an average shred characterization of from about 15% to about 20% by weight of large pieces. In yet another embodiment, the structured protein products have an average shred characterization of from about 20% to about 25% by weight of large pieces. In another embodiment, the average shred characterization is at least 20% by weight, at least 21% by weight, at least 22% by weight, at least 23% by weight, at least 24% by weight, at least 25% by weight, or at least 26% by weight large pieces.

Suitable structured protein products of the invention generally have protein fibers that are substantially aligned, have average shear strength of at least 1400 grams, and have an average shred characterization of at least 10% by weight large pieces. More typically, the structured protein products will have protein fibers that are at least 55% aligned, have average shear strength of at least 1800 grams, and have an average shred characterization of at least 15% by weight large pieces. In exemplary embodiment, the structured protein products will have protein fibers that are at least 55% aligned, have average shear strength of at least 2000 grams, and have an average shred characterization of at least 17% by weight large pieces. In another exemplary embodiment, the structured protein products will have protein fibers that are at least 55% aligned, have average shear strength of at least 2200 grams, and have an average shred characterization of at least 20% by weight large pieces. In a further embodiment, the structured protein products will have protein fibers that are at least 55% aligned, have average shear strength of at least 2400 grams, and have an average shred characterization of at least 20% by weight large pieces.

B Animal Meat

The processed meat composition of the invention further comprises a reprocessed animal meat product. The reprocessed animal meat product is typically pieces of processed meat products leftover during the manufacture of processed meat products. The processed meat composition of the invention optionally may further comprise uncooked animal meat in the formulation.

(a) Reprocessed Animal Meat Product

Typically, the reprocessed animal meat product will be pieces of processed meat product that were leftover during the manufacture of processed meat products. The processed meat product may be broken, misshapen, have a split casing, be unevenly smoked, be an unusable end piece, and so forth. Non-limiting examples of suitable reprocessed animal meat products that may be included in the composition of the invention reprocessed animal meat products selected from the group consisting of hot dogs, sausages, kielbasa, chorizo, bologna, hams, bacon, luncheon meat products, canned ground meat products, canned emulsified meat products, and mixtures thereof. The reprocessed animal meat product may comprise meat from cattle, swine, lamb, goats, wild game, poultry, fowl, fish, and/or seafood, as detailed below. Unless sealed under sterile conditions or frozen, the reprocessed meat product will generally be stored at a temperature of 4° C. or less.

(b) Uncooked Animal Meat

The processed meat composition optionally may further comprise uncooked animal meat in the formulation. The animal meat used is preferably any meat useful for forming sausages, frankfurters or other processed meat products. The animal meat may be useful for filling a permeable or impermeable casing and/or may be useful in ground meat applications, such as hamburgers, meat loaf, and minced meat products.

The term “meat” is understood to apply not only to the flesh of cattle, swine, sheep and goats, but also horses, whales and other mammals, poultry and fish. The term “meat by-products” is intended to refer to those non-rendered parts of the carcass of slaughtered animals including but not restricted to mammals, poultry and the like and including such constituents as are embraced by the term “meat by-products” in the Definitions of Feed Ingredients published by the Association of American Feed Control Officials, Incorporated. The terms “meat,” and “meat by-products,” are understood to apply to all of those animal, poultry and marine products defined by association.

The animal meat may be mammalian meat such as from a farm animal selected from the group consisting of sheep, cattle, goats, pork, and horses. The animal meat may be from poultry or fowl, such as chicken, duck, goose or turkey. Alternatively, the animal meat may be from a game animal. Non-limiting examples of suitable game animals include buffalo, deer, elk, moose, reindeer, caribou, antelope, rabbit, squirrel, beaver, muskrat, opossum, raccoon, armadillo, porcupine, and snake. In a further embodiment, the animal meat may be from fish or seafood. Non-limiting examples of suitable fish include bass, carp, catfish, cobia, cod, grouper, flounder, haddock, hoki, perch, pollock, salmon, snapper, sole, trout, tuna, whitefish, and whiting. Non-limiting examples of seafood include shrimp, lobster, clams, crabs, mussels, and oysters.

By way of example, meat and meat ingredients defined specifically for the various structured vegetable protein patents include intact or ground beef, pork, lamb, mutton, horsemeat, goat meat, meat, fat and skin of poultry (domestic fowl such as chicken, duck, goose or turkey) and more specifically flesh tissues from any fowl (any bird species), fish flesh derived from both fresh and salt water fish such as catfish, tuna, sturgeon, salmon, bass, muskie, pike, bowfin, gar, paddlefish, bream, carp, trout, walleye, snakehead and crappie, animal flesh of shellfish and crustacean origin, animal flesh trim and animal tissues derived from processing such as frozen residue from sawing frozen fish, chicken, beef, pork etc., chicken skin, pork skin, fish skin, animal fats such as beef fat, pork fat, lamb fat, chicken fat, turkey fat, rendered animal fat such as lard and tallow, flavor enhanced animal fats, fractionated or further processed animal fat tissue, finely textured beef, finely textured pork, finely textured lamb, finely textured chicken, low temperature rendered animal tissues such as low temperature rendered beef and low temperature rendered pork, mechanically separated meat or mechanically deboned meat (MDM) (meat flesh removed from bone by various mechanical means) such as mechanically separated beef, mechanically separated pork, mechanically separated fish, mechanically separated chicken, mechanically separated turkey, any cooked animal flesh and organ meats derived from any animal species. Meat flesh should be extended to include muscle protein fractions derived from salt fractionation of the animal tissues, protein ingredients derived from isoelectric fractionation and precipitation of animal muscle or meat and hot boned meat as well as mechanically prepared collagen tissues and gelatin. Additionally, meat, fat, connective tissue and organ meats of game animals such as buffalo, deer, elk, moose, reindeer, caribou, antelope, rabbit, bear, squirrel, beaver, muskrat, opossum, raccoon, armadillo and porcupine as well as well as reptilian creatures such as snakes, turtles and lizards should be considered meat.

By way of example, meat includes striated muscle, which is skeletal muscle, or smooth muscle that is found, for example, in the tongue, diaphragm, heart, or esophagus, with or without accompanying overlying fat and portions of the skin, sinew, nerve and blood vessels which normally accompany the meat flesh. Examples of meat by-products are organs and tissues such as lungs, spleens, kidneys, brain, liver, blood, bone, partially defatted low-temperature fatty tissues, stomachs, intestines free of their contents, and the like. Poultry by-products include non-rendered, clean parts of carcasses, such as heads, feet, and viscera, free from fecal content and foreign matter.

It is also envisioned that a variety of meat forms may be utilized in the invention depending upon the product's intended use. For example, whole meat muscle that is either ground or in chunk or steak form may be utilized. In an additional embodiment, whole muscle meat pieces may be used that are unaltered or are intact pieces of meat. In a further embodiment, mechanically deboned meat (MDM) may be utilized. In the context of the present invention, MDM is any mechanically deboned meat including a meat paste that is recovered from a variety of animal bones, such as, beef, pork and chicken bones, using commercially available equipment. MDM is generally an untexturized comminuted product that is devoid of the natural fibrous texture found in intact muscles. In other embodiments, a combination of MDM and whole meat muscle may be utilized.

It is well known in the art to produce mechanically deboned or separated raw meats using high-pressure machinery that separates bone from animal tissue, by first crushing bone and adhering animal tissue and then forcing the animal tissue, and not the bone, through a sieve or similar screening device. The animal tissue in the present invention may comprise muscle tissue, organ tissue, connective tissue, and skin. The process forms an untexturized, paste-like blend of soft animal tissue with a batter-like consistency and is commonly referred to as MDM. This paste-like blend has a particle size of from about 0.25 to about 10 millimeters. In another embodiment, the particle size is up to about 5 millimeters. In a further embodiment, the particle size is up to about 3 millimeters.

Although the animal tissue, also known as raw meat, is preferably provided in at least substantially frozen form so as to avoid microbial spoilage prior to processing, once the meat is ground, it is not necessary to freeze it to provide cutability into individual strips or pieces. Unlike meat meal, raw meat has a natural high moisture content of above about 50% and the protein is not denatured.

The raw (uncooked) animal meat used in the present invention may be any edible meat suitable for human consumption. The meat may be non-rendered, non-dried, raw meat, raw meat products, raw meat by-products, and mixtures thereof. The animal meat or meat products including the comminuted meat products are generally supplied daily in a completely frozen or at least substantially frozen condition so as to avoid microbial spoilage. In one embodiment, the temperature of the animal meat is below about −40° C. In another embodiment, the temperature of the meat is below about −20° C. In yet another embodiment, the temperature of the meat is from about −4° C. to about 6° C. In a further embodiment, the temperature of the meat is from about −2° C. to about 2° C. While refrigerated or chilled meat may be used, it is generally impractical to store large quantities of unfrozen meat for extended periods of time at a plant site. The frozen products provide a longer lay time than do the refrigerated or chilled products. Non-limiting examples of animal meat products which may be used in the process of the present invention include pork shoulder, beef shoulder, beef flank, turkey thigh, beef liver, ox heart, pigs heart, pork heads, pork skirt, beef mechanically deboned meat, pork mechanically deboned meat, and chicken mechanically deboned meat.

In lieu of frozen animal meat, the animal meat may be freshly prepared for the preparation of the processed meat product, as long as the freshly prepared animal meat is stored at a temperature that does not exceed about 4° C.

The moisture content of the raw frozen or unfrozen meat is generally at least about 50% by weight, and most often from about 60% by weight to about 75% by weight, based upon the weight of the raw meat. In embodiments of the invention, the fat content of the raw frozen or unfrozen meat may be at least 2% by weight, generally from about 15% by weight to about 50% by weight. In other embodiments of the invention, meat products having a fat content of less than about 10% by weight and defatted meat products may be used.

The frozen or chilled meat may be stored at a temperature of about −18° C. to about 0° C. It is generally supplied in 20 kilogram blocks. The frozen blocks of meat may be whole muscle meat, chunks of meat, or ground meat. Upon use, the blocks are permitted to thaw up to about 10° C., that is, to defrost, but in a tempered environment. Thus, the outer layer of the blocks, for example up to a depth of about ¼ inch, may be defrosted or thawed but still at a temperature of about 0° C., while the remaining inner portion of the blocks, while still frozen, are continuing to thaw and thus keeping the outer portion at below about 10° C.

### (II) Preparing Processed Meat Compositions and Food Products Comprising Processed Meat Compositions

A processed meat composition may be formulated from a structured protein product and a reprocessed animal meat product. Alternatively, a processed meat product may be formulated from a structured protein product, a reprocessed animal meat product, and uncooked animal meat. The process for producing a processed meat product generally comprises hydrating the structured protein product, reducing its particle size if necessary, optionally flavoring and coloring the structured protein product, mixing it with the reprocessed animal meat product, optionally mixing it with uncooked animal meat, and further processing the composition into a food product.

### A Hydrating the Structured Protein Product

The structured protein product may be mixed with water to rehydrate it. The amount of water added to the structured protein product can and will vary. The ratio of water to structured protein product may range from about 1.5:1 to about 4:1. In one embodiment, the ratio of water to structured protein product may be about 2.5:1. In another embodiment, the ratio of water to structured protein product may be about 3-1.

The concentration of structured protein product in the processed meat composition may be about 1%, 5%, 10%. 15%, 20%, 25%, 30%, 35%, 40%, 45%, or 50% by weight. In a preferred embodiment, the concentration of structured protein product may range from about 5% to about 40% by weight. In another preferred embodiment, the concentration of structured protein product may be about 10% by weight.

The particle size of the structured protein product may be further reduced by grinding, shredding, cutting, or chopping the hydrated product. The particle size can and will vary depending upon the processed meat product being made. Typically, the reduced hydrated product has an average particle size of from about 0.1 mm to about 40.0 mm. In one embodiment, the reduced hydrated product has an average particle size of from about 5.0 mm to about 30.0 mm. In another embodiment, the reduced hydrated product has an average particle size of from about 0.5 mm to about 20.0 mm. In a further embodiment, the reduced hydrated product has an average particle size of from about 0.5 mm to about 15.0 mm. In an additional embodiment, the reduced hydrated product has an average particle size of from about 0.75 mm to about 10.0 mm. In yet another embodiment, the reduced hydrated product has an average particle size of from about 1.0 mm to about 5.0 mm. Suitable apparatus for reducing particle size include hammer mills, such as Fitz Mill manufactured by She Hui Machinery Co., Ltd., and Comitrols, such as those manufactured by Urschel Laboratories, Inc.

B Blending with Reprocessed Meat Product

The process further comprises blending the hydrated, structured protein product with a reprocessed animal meat product, which was described above in section IB. The reprocessed meat product may be ground or shredded, the diameter or consistency of which can and will vary depending upon the application. In general, the hydrated structured protein product will be blended with reprocessed meat product that has a similar particle size.

The concentration of the reprocessed meat product in the processed meat composition of the invention may be about 5%, 10%. 15%, 20%, 25%, 30%, 35%, 40%, 45%, 50%, 55%, 60%, 65%, 70%, 75%, or 80% by weight. In a preferred embodiment the concentration of the reprocessed meat product may range from about 10% to about 60% by weight. In another preferred embodiment, the concentration of the reprocessed meat product may range from about 40% to about 50% by weight.

C Blending with Other Ingredients

### (a) Optional Uncooked Meat

The processed meat composition of the invention may optionally include uncooked animal meat in the formulation. Suitable meats were described above in section IBb. The concentration of uncooked animal meat may be about 1%, 5%, 10%, 15%, 20%, 25%, 30%, 35%, 40%, 45%, or 50%. In a preferred embodiment, the concentration of uncooked meat in the processed meat formulation may range from about 5% to about 30% by weight. In another embodiment, the concentration of the uncooked meat may be about 10% by weight. In general, the particle size of the uncooked animal meat will be the same particle size or have a smaller particle size that that of the blend of structure protein product and reprocessed meat product.

(b) Optional pH-Lowering Agent

The processed meat composition optionally may also comprise a pH-lowering agent. Several pH-lowering agents are suitable for use in the invention. The pH-lowering agent may be inorganic. Alternatively, the pH-lowering agent may be organic. In exemplary embodiments, the pH-lowering agent is a food grade edible acid. Non-limiting acids suitable for use in the invention include acetic, lactic, hydrochloric, phosphoric, citric, tartaric, malic, and combinations thereof. In an exemplary embodiment, the pH-lowering agent is lactic acid.

The amount of pH-lowering agent utilized in the invention can and will vary depending upon a variety of parameters. By way of non-limiting example, the amount of pH-lowering agent way may range from about 0.01% to about 10% by weight. In another embodiment, the amount of pH-lowering agent may range from about 0.05% to about 5% by weight. In a preferred embodiment, the amount of pH-lowering agent may range from about 0.1% to about 3% by weight.

### (c) Optional Colorant

It is also envisioned that the processed meat composition may be combined with a suitable colorant(s) such that the color of the composition resembles the color of processed animal meat it simulates. The compositions of the invention may be colored to resemble dark animal meat or lighter animal meat. By way of example, the composition may be colored with a natural colorant, a combination of natural colorants, an artificial colorant, a combination of artificial colorants, or a combination of natural and artificial colorants. Examples of suitable colorants were listed above in section IAb. The type of colorant or colorants and the concentration of the colorant or colorants will be adjusted to match the color of the processed animal meat to be simulated. The final concentration of a natural food colorant may range from about 0.01% percent to about 4% by weight. The meat composition may further comprise an acidity regulator to maintain the pH in the optimal range for the colorant. The acidity regulator may be an acidulent. Examples of suitable acidulents were listed above in section IAb. The acidity regulator may also be a pH-raising agent, such as disodium diphosphate.

### (d) Optional Other Ingredients

The processed meat compositions may also optionally include isolated soy protein. The concentration of the isolated soy protein may range from about 1% to about 20% by weight. In one embodiment, the concentration of the isolated soy protein may range from about 2% to about 15% by weight. In another embodiment, the concentration of the isolated soy protein may range from about 5% to about 10% by weight.

A thickening or a gelling agent may also be included in the processed meat compositions. Suitable thickening agents include alginic acid and its salts, agar, carrageenan and its salts, processed Eucheuma seaweed, gums (carob bean, guar, tragacanth, and xanthan), pectins, sodium carboxymethylcellulose, and modified starches.

The processed meat compositions optionally may also include a curing agent. Suitable curing agents include sodium tripolyphosphate, sodium chloride, sodium nitrite, sodium nitrate, potassium nitrate, potassium nitrate, sodium erythorbate, and the like. The concentration of the curing agent may range from about 0.0001% to about 5% by weight, and more preferably from about 0.001% to about 2% by weight. The curing agent may also optionally include a sugar. Suitable sugars include glucose (or dextrose), maple syrup, corn syrup, corn syrup solids, sucrose, honey, and sorbitol. The final concentration of the sugar in the processed meat composition may range from about 0.1% to about 2% by weight.

An antioxidant may also be included in the processed meat compositions. The antioxidant may prevent the oxidation of the polyunsaturated fatty acids in the meat products, and the antioxidant may also prevent oxidative color changes in the processed meat products. The antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, m-aminobenzoic acid, o-aminobenzoic acid, p-aminobenzoic acid (PABA), butylated hydroxyanisole (BHA), butylated hydroxytoluene (BHT), caffeic acid, canthaxantin, alpha-carotene, beta-carotene, beta-caraotene, beta-apo-carotenoic acid, carnosol, carvacrol, catechins, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, rice bran extract, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, and combinations thereof.

The concentration of an antioxidant in the processed meat composition may range from about 0.0001% to about 20% by weight. In another embodiment, the concentration of an antioxidant in an animal meat composition may range from about 0.001% to about 5% by weight. In yet another embodiment, the concentration of an antioxidant in an animal meat composition may range from about 0.01% to about 1% by weight.

The processed meat compositions may also optionally include a variety of flavorings, spices, or other ingredients to enhance the flavor of the final food product. As will be appreciated by a skilled artisan, the selection of ingredients added to the processed meat composition can and will depend upon the food product to be manufactured. For example, the processed meat compositions may further comprise a flavoring agent such as an animal meat flavor, an animal meat oil, spice extracts, spice oils, natural smoke solutions, natural smoke extracts, yeast extract, mushroom extract, and shiitake extract. Additional flavoring agents may include onion flavor, garlic flavor, or herb flavors. The processed meat composition may further comprise a flavor enhancer. Examples of flavor enhancers that may be used include salt, glutamic acid salts (e.g., monosodium glutamate), glycine salts, guanylic acid salts, inosinic acid salts, 5′-ribonucleotide salts, hydrolyzed proteins, and hydrolyzed vegetable proteins. Herbs or spices that may be added include allspice, basil, bay leaves, black pepper, caraway seeds, cayenne, celery leaves, chervil, chili pepper, chives, cilantro, cinnamon, cloves, coriander, cumin, dill, fennel, ginger, marjoram, mustard, nutmeg, paprika, parsley, oregano, rosemary, saffron, sage, savory, tarragon, thyme, and white pepper.

Lastly, the processed meat compositions may also further comprise a nutrient such as a vitamin, a mineral, or an omega-3 fatty acid to nutritionally enhance the final product. Suitable vitamins include Vitamins A, C, and E, which are also antioxidants, and Vitamins B and D. Examples of minerals that may be added include the salts of aluminum, ammonium, calcium, magnesium, and potassium. Suitable omega-3 fatty acids include docosahexaenoic acid (DHA).

D Processing into Processed Meat Products

Selected amounts of structured protein product, water, and processed meat product, within the ranges set forth above, may be added together in a mixing or chopping bowl, together with any additional desired ingredients such as uncooked animal meat, pH-lowering agents, flavorings, colorants, and/or preservatives. The mixture may be blended by stirring, agitating, or mixing the ingredients for a period of time sufficient to form a homogenous blend. Alternatively, the ingredients may be added separately after each previous ingredient is thoroughly mixed into the mixture, e.g., the hydrated structured protein product may be blended with at least one colorant, then the cooked meat product may be added and thoroughly blended, and then each of the additional ingredients may be added and blended until a homogenous mixture is formed.

Conventional means for stirring, agitating, or mixing the mixture may be used to create a homogeneous blend. The blending of the mixture may be performed with a bowl chopper that chops the materials in the mixture with a knife, or a mixer/emulsifier system that ultimately minces a pre-extracted mixture of meat and structured protein ingredient. Non-limiting exemplary chopper/mixer/emulsifiers include a bowl chopper such as the Alpina model PBV 90 20, a mince mill such as a Stefhan model Microcut MC 15, an emulsifier such as the Cozzini continuous emulsifier model AR 701, or the Hobart Food Cutter Model No. 84142.

The meat mixture typically will then be processed into a variety of food products having a variety of shapes for either human or animal consumption. Non-limiting examples of products that may be formed with the meat mixture include hotdogs, wieners, frankfurters, sausage links, sausage rings, bologna rolls, luncheon meat rolls or loaves, and canned ground, minced, or emulsified meat products. The first of the processing steps is the formation of the final meat product. In one embodiment, the meat mixture may be pumped into casings to form hot dogs, sausages, or bologna rolls. The casing may be a permeable casing, such as a cellulose casing, a fibrous casing, a collagen casing, or a natural membrane. Alternatively, or the casing may be an impermeable plastic casing. One skilled in the art will appreciate that the length and diameter of the casing can and will vary depending upon the product being manufactured. In another embodiment, the meat mixture may be formed into patties, links, or other shapes before being processed further. The formed meat product may be coated with a batter and/or it may be coated with a breading. In yet another embodiment, the meat mixture may be introduced into a sealable package, pouch, or can for further processing. In a preferred embodiment, the meat mixture is stuffed into a casing to form a hot dog, a frankfurter, or a sausage.

Once the food product is shaped or formed, it is then further processed. The processing may include cooking, partial cooking, freezing, or any method known in the art for producing a shelf stable product. In one embodiment, the formed food product is cooked on-site. Any method known in the art for cooking the final meat product may be used. Non-limiting examples of cooking methods include hot water cooking, steam cooking, par-boiling, par-frying, frying, retort cooking, hot smoke cooking under controlled humidity, and oven methods, including microwave, traditional, and convection. Typically, a meat product is cooked to an internal temperature of at least 70° C. Prior to cooking, some meat products may be wet or dried cured by storing them at a temperature of about 4° C. for a period of time. The period of time of curing can and will vary depending on the final product being made. Furthermore, some meat products may be subjected to a period of smoking before or during cooking.

In one embodiment, the meat product may be cooked in hot water cooker, preferably at about 80° C., to an internal temperature of about 70° C. to about 80° C. In another embodiment, the meat product may be cooked by steam, to an internal temperature of about 70° C. to about 80° C. In an alternative embodiment, the meat product may be cooked in a smokehouse under controlled temperature and humidity, to an internal temperature of about 70° C. to about 80° C. In another embodiment, the meat product, either cooked or uncooked, may be packed and sealed in cans in a conventional manner and employing conventional sealing procedures in preparation for sterilization by retorting. In still another embodiment, the final meat product may be partially cooked for finishing at a later time, or frozen either in an uncooked state, partially cooked state, or cooked state. Any of the foregoing products may be sealed in plastic, placed in a tray with overwrap, vacuum packed, retort canned or pouched, or frozen.

It is also envisioned that the processed meat compositions of the present invention may be utilized in a variety of animal diets. In one embodiment, the final product may be an animal meat composition formulated for companion animal consumption. In another embodiment, the final product may be an animal meat composition formulated for agricultural or zoo animal consumption. A skilled artisan can readily formulate the meat compositions for use in companion animal, agricultural animal or zoo animal diets.

### Definitions

The terms “animal meat” or “meat” as used herein to the muscles, organs, and by-products thereof derived from an animal, wherein the animal may be a land animal or an aquatic animal.

The term “comminuted meat” as used herein refers to a meat paste that is recovered from an animal carcass. The meat, on the bone is forced through a deboning device such that meat is separated from the bone and reduced in size. Meat that is off the bone would not be further treated with a deboning device. The meat is separated from the meat/bone mixture by forcing through a cylinder with small diameter holes. The meat acts as a liquid and is forced through the holes while the remaining bone material remains behind. The fat content of the comminuted meat may be adjusted upward by the addition of animal fat.

The term “extrudate” as used herein refers to the product of extrusion. In this context, the structured protein products comprising protein fibers that are substantially aligned may be extrudates in some embodiments.

The term “fiber” as used herein refers to a structured protein product having a size of approximately 4 centimeters in length and 0.2 centimeters in width after the shred characterization test detailed in Example 4 is performed.

The term “gluten” as used herein refers to a protein fraction in cereal grain flour, such as wheat, that possesses a high content of protein as well as unique structural and adhesive properties.

The term “large piece” as used herein is the manner in which a structured protein product's shred percentage is characterized. The determination of shred characterization is detailed in Example 2.

The term “processed meat” as used herein refers to a meat product that is cooked, and may be salted, cured, preserved, and/or smoked.

The term “protein fiber” as used herein refers the individual continuous filaments or discrete elongated pieces of varying lengths that together define the structure of the protein products of the invention. Additionally, because the protein products of the invention have protein fibers that are substantially aligned, the arrangement of the protein fibers impart the texture of whole meat muscle to the protein products.

The term “soy cotyledon fiber” as used herein refers to the polysaccharide portion of soy cotyledons containing at least about 70% dietary fiber. Soy cotyledon fiber typically contains some minor amounts of soy protein, but may also be 100% fiber. Soy cotyledon fiber, as used herein, does not refer to, or include, soy hull fiber. Generally, soy cotyledon fiber is formed from soybeans by removing the hull and germ of the soybean, flaking or grinding the cotyledon and removing oil from the flaked or ground cotyledon, and separating the soy cotyledon fiber from the soy material and carbohydrates of the cotyledon.

The term “soy flour” as used herein, refers to full fat soy flour, enzyme-active soy flour, defatted soy flour and mixtures thereof. Defatted soy flour refers to a comminuted form of defatted soybean material, preferably containing less than about 1% oil, formed of particles having a size such that the particles can pass through a No. 100 mesh (U.S. Standard) screen. The soy cake, chips, flakes, meal, or mixture of the materials are comminuted into soy flour using conventional soy grinding processes. Soy flour has a soy protein content of about 49% to about 65% on a moisture free basis. Preferably the flour is very finely ground, most preferably so that less than about 1% of the flour is retained on a 300 mesh (U.S. Standard) screen. Full fat soy flour refers to ground whole soybeans containing all of the original oil, usually 18 to 20%. The flour may be enzyme-active or it may be heat-processed or toasted to minimize enzyme activity. Enzyme-active soy flour refers to a full fat soy flour that has been minimally heat-treated in order not to neutralize its natural enzymes.

The term “soy protein concentrate” as used herein is a soy material having a protein content of from about 65% to less than about 90% soy protein on a moisture-free basis. Soy protein concentrate also contains soy cotyledon fiber, typically from about 3.5% up to about 20% soy cotyledon fiber by weight on a moisture-free basis. A soy protein concentrate is formed from soybeans by removing the hull and germ of the soybean, flaking or grinding the cotyledon and removing oil from the flaked or ground cotyledon, and separating the soy protein and soy cotyledon fiber from the soluble carbohydrates of the cotyledon.

The term “soy protein isolate” as used herein is a soy material having a protein content of at least about 90% soy protein on a moisture free basis. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

The term “starch” as used herein refers to starches derived from any native source. Typically sources for starch are cereals, tubers, and roots.

The term “strand” as used herein refers to a structured protein product having a size of approximately 2.5 to about 4 centimeters in length and greater than approximately 0.2 centimeter in width after the shred characterization test detailed in Example 4 is performed.

The term “wheat flour” as used herein refers to flour obtained from the milling of wheat. Generally speaking, the particle size of wheat flour is from about 14 to about 120 μm.

The invention having been generally described above, may be better understood by reference to the examples described below. The following examples represent specific but non-limiting embodiments of the present invention.

### EXAMPLES

The following examples illustrate various embodiments of the invention.

### Example 1

### Determination of Shear Strength of the Structured Protein Product

Shear strength of a sample is measured in grams and may be determined by the following procedure. Weigh a sample of the structured protein product and place it in a heat sealable pouch and hydrate the sample with approximately three times the sample weight of room temperature tap water. Evacuate the pouch to a pressure of about 0.01 Bar and seal the pouch. Permit the sample to hydrate for about 12 to about 24 hours. Remove the hydrated sample and place it on the texture analyzer base plate oriented so that a knife from the texture analyzer will cut through the diameter of the sample. Further, the sample should be oriented under the texture analyzer knife such that the knife cuts perpendicular to the long axis of the textured piece. A suitable knife used to cut the extrudate is a model TA-45, incisor blade manufactured by Texture Technologies (USA). A suitable texture analyzer to perform this test is a model TA, TXT2 manufactured by Stable Micro Systems Ltd. (England) equipped with a 25, 50, or 100 kilogram load. Within the context of this test, shear strength is the maximum force in grams needed to shear through the sample.

### Example 2

### Determination of Shred Characterization of the Structured Protein Product

A procedure for determining shred characterization may be performed as follows. Weigh about 150 grams of a structured protein product using whole pieces only. Place the sample into a heat-sealable plastic bag and add about 450 grams of water at 25° C. Vacuum seal the bag at about 150 mm Hg and allow the contents to hydrate for about 60 minutes. Place the hydrated sample in the bowl of a Kitchen Aid mixer model KM14G0 equipped with a single blade paddle and mix the contents at 130 rpm for two minutes. Scrape the paddle and the sides of the bowl, returning the scrapings to the bottom of the bowl. Repeat the mixing and scraping two times. Remove ˜200 g of the mixture from the bowl. Separate the ˜200 g of mixture into one of two groups. Group 1 is the portion of the sample having fibers at least 4 centimeters in length and at least 0.2 centimeters wide. Group 2 is the portion of the sample having strands between 2.5 cm and 4.0 cm long, and which are ≧0.2 cm wide. Weigh each group, and record the weight. Add the weight of each group together, and divide by the starting weight (e.g. ˜200 g). This determines the percentage of large pieces in the sample. If the resulting value is below 15%, or above 20%, the test is complete. If the value is between 15% and 20%, then weigh out another 200 g from the bowl, separate the mixture into groups one and two, and perform the calculations again.

### Example 3

### Production of Structured Protein Products

The following extrusion process may be used to prepare the structured protein products of the invention, such as the soy structured plant protein products utilized in Examples 1 and 2. Added to a dry blend mixing tank are the following: 1000 kilograms (kg) Supro 620 (soy protein isolate), 440 kg wheat gluten, 171 kg wheat starch, 34 kg soy cotyledon fiber, 9 kg dicalcium phosphate, and 1 kg L-cysteine. The contents are mixed to form a dry blended soy protein mixture. The dry blend is then transferred to a hopper from which the dry blend is introduced into a preconditioner along with 480 kg of water to form a conditioned soy protein pre-mixture. The conditioned soy protein pre-mixture is then fed to a twin-screw extrusion apparatus at a rate of not more than 75 kg/minute. The extrusion apparatus comprises five temperature control zones, with the protein mixture being controlled to a temperature of from about 25° C. in the first zone, about 50° C. in the second zone, about 95° C. in the third zone, about 130° C. in the fourth zone, and about 150° C. in the fifth zone. The extrusion mass is subjected to a pressure of at least about 400 psig in the first zone up to about 1500 psig in the fifth zone. Water, 60 kg, is injected into the extruder barrel, via one or more injection jets in communication with a heating zone. The molten extruder mass exits the extruder barrel through a die assembly consisting of a die and a backplate. As the mass flows through the die assembly the protein fibers contained within are substantially aligned with one another forming a fibrous extrudate. As the fibrous extrudate exits the die assembly, it is cut with flexible knives and the cut mass is then dried to a moisture content of about 10% by weight.

During the production of processed meat products, defective products are typically generated. Products with defects include those that break, split open, are misshapen, have uneven smoking, as well as leftover ends and pieces. Products with defects are not sold in the marketplace, but rather may be “reworked” and added back to a meat product formulation at a low level (no more than about 10%. Only low levels may be used because the denatured protein of the processed meat product no longer serves as a binder and acts only as filler. In this invention, a new processed meat product is developed that generally comprises two components—a structured protein product (SPP) and a reprocessed animal meat product. The SPP is generally present in the processed meat product at from about 25% by weight up to about 75% by weight with the remainder being the reprocessed animal that is present in the processed meat product from about 25% by weight up to about 75% by weight. The SPP is preferably present in the processed meat product at from about 30% by weight up to about 70% by weight with the remainder being the reprocessed animal that is present in the processed meat product from about 30% by weight up to about 70% by weight. The SPP is most preferably present in the processed meat product at from about 40% by weight up to about 60% by weight with the remainder being the reprocessed animal that is present in the processed meat product from about 40% by weight up to about 60% by weight. These new processed meat products comprising the structured protein product not only efficiently utilize reworked processed meat, but also have better nutritional profiles and reduced costs compared to those of traditional “all meat” processed meat products.

### Example 4

### Processed Meat Products Comprising Structured Protein Products and Reprocessed Meat Products

Several different processed meat products were prepared, as detailed in Table 1. The processed meat products that were made and compared were: 1) a control product comprising chicken mechanically deboned meat (MDM); 2) a test product comprising SPP and reworked processed meat product; 3) a test product comprising SPP, reworked processed meat product, and lactic acid (LA); and 4) a test product comprising SPP, chicken MDM, and reworked processed meat product. The SPP (SuproMax 5050) comprised isolated soy protein (ISP), wheat gluten, wheat starch, soy fiber, L-cysteine, and dicalcium phosphate.

TABLE 1
Processed Meat Product Formulations

| | #1 | | | |
|---|---|---|---|---|
| | (Control) | #2 | #3 | #4 |
| Ingredient | (%) | (%) | (%) | (%) |
| Chicken MDM (18% fat) | 71.740 | — | — | 10.000 |
| Water | 16.000 | 31.880 | 31.480 | 31.880 |
| Supro 500E (ISP) (3% fat) | — | 6.000 | 6.000 | 6.000 |
| SuproMax 5050 (SPP) (4% fat) | — | 10.000 | 10.000 | 10.000 |
| Soy concentrate (2% fat) | 6.900 | — | — | — |
| Tapioca starch | 2.000 | — | — | — |
| Salt | 2.000 | 1.000 | 1.000 | 1.000 |
| Sodium nitrite | 0.015 | 0.008 | 0.008 | 0.008 |
| Sodium tripolyphosphate | 0.300 | — | — | — |
| Spices | 1.000 | 1.000 | 1.000 | 1.000 |
| Erythorbate | 0.045 | 0.022 | 0.022 | 0.022 |
| Carmine | — | 0.090 | 0.090 | 0.090 |
| Hot dog rework (13.15% fat) | — | 50.000 | 50.000 | 40.000 |
| Lactic acid (85%) | — | — | 0.400 | — |

The structured protein product was hydrated and shredded, and the hot dog rework was passed through a 3-mm grinder plate. The ingredients of each formulation were mixed together and chopped at high speed in a bowl chopper (e.g., Alpina model PBV 90-20) to a final meat batter of 55-60° F. (12.5-15.5° C.). Cellulose casing was filled with the batter, and then the each processed meat products was smoked, cooked, chilled, and packaged. FIG. 6 presents photographs of processed sausages and luncheon meat comprising structured protein product and reworked processed meat product.

Compositional analyses of the control product and the three processed meat products comprising structured protein product and reworked processed meat product are presented in Table 2. The processed meat products comprising structured protein product were higher in total protein and lower in total fat than the traditional “all meat” control product.

TABLE 2
Composition of Processed Meat Products

| | #1 | #2 | #3 | #4 |
|---|---|---|---|---|
| Total protein (%) | 14.03 | 19.07 | 18.98 | 18.98 |
| Total fat (%) | 13.15 | 7.26 | 7.74 | 7.74 |
| Carbohydrate (%) | 3.91 | 4.06 | 3.86 | 3.66 |
| Moisture (%) | 65.18 | 66.03 | 66.02 | 66.26 |

### Example 5

### Texture Profile Analysis (TPA) of the Processed Meat Products

The textural properties (i.e., hardness, elasticity, cohesiveness, gumminess, and chewiness) of the processed meat products prepared in Example 1 were compared. This analysis was conducted using a TA.XT2i Texture Analyzer (Stable MicroSystems, Ltd., Surrey, UK). Seven or eight samples of each formulation were tested. Table 3 presents the mean and standard error of the mean (SEM) for each product (hardness is expressed in grams, the other parameters are unit-less). The processed meat products comprising structured protein product and reworked processed meat outperformed the control product in every parameter measured.

TABLE 3
TPA Analysis

| | #1 (pH 6.3) | | #3 (pH 5.7) | | #2 (pH 6.3) | |
|---|---|---|---|---|---|---|
| Parameter | Mean | SEM | Mean | SEM | Mean | SEM |
| Hardness | 1181.0 | 47.2 | 1911.1 | 45.5 | 2199.4 | 54.8 |
| Elasticity | 0.2090 | 0.0028 | 0.5368 | 0.0124 | 0.5096 | 0.0125 |
| Cohesiveness | 0.2106 | 0.0015 | 0.3425 | 0.0053 | 0.3293 | 0.0086 |
| Gumminess | 248.8 | 10.0 | 653.5 | 12.9 | 723.1 | 20.6 |
| Chewiness | 52.1 | 2.4 | 231.0 | 11.8 | 367.6 | 10.3 |

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A processed animal meat composition comprising:
(a) a structured protein product, the product having protein fibers that are substantially aligned; and
(b) a reprocessed animal meat product.

2. The processed animal meat composition of claim 1, wherein the composition comprises from about 25% to about 75% by weight of the structured protein product, and from about 25% to about 75% by weight of the reprocessed animal meat product.

3. The processed animal meat composition of claim 1, wherein the structured protein product comprises protein material selected from the group consisting of soy, wheat, canola, corn, lupin, oat, pea, rice, sorghum, dairy, whey, egg, and mixtures thereof.

4. The processed animal meat composition of claim 3, wherein the structured protein product is extruded through a die assembly resulting in a structured protein product having protein fibers that are substantially aligned.

5. The processed animal meat composition of claim 4, wherein the structured protein product comprises protein fibers substantially aligned in the manner depicted in the micrographic image of FIG. 1.

6. The processed animal meat composition of claim 5, wherein the structured protein product has an average shear strength of at least 2000 grams and an average shred characterization of at least 17%.

7. The processed animal meat composition of claim 5, wherein the structured protein product comprises soy protein and wheat protein.

8. The processed animal meat composition of claim 7, wherein the structured protein product further comprises whey protein.

9. The processed animal meat composition of claim 7, wherein the structured protein product has from about 40% to about 75% protein on a dry mater basis.

10. The processed animal meat composition of claim 9, wherein the structured protein product comprises protein, starch, gluten, and fiber.

11. The processed animal meat composition of claim 10, wherein the structured protein product comprises:
(a) from about 45% to about 65% soy protein on a dry matter basis;
(b) from about 20% to about 30% wheat gluten on a dry matter basis;
(c) from about 10% to about 15% wheat starch on a dry matter basis; and
(d) from about 1% to about 5% fiber on a dry matter basis.

12. The processed animal meat composition of claim 1, wherein the reprocessed animal meat product is a product selected from the group consisting of hot dogs, sausages, kielbasa, chorizo, bologna, hams, bacon, luncheon meat products, canned ground meat products, canned emulsified meat products, and mixtures thereof.

13. The processed animal meat composition claim 12, wherein the meat product is derived from an animal selected from the group consisting of pork, beef, lamb, poultry, fowl, wild game, seafood, and mixtures thereof.

14. The processed animal meat composition of claim 1, further comprising uncooked animal meat in the formulation.

15. The processed animal meat composition of claim 14, wherein the concentration of the uncooked animal meat in the formulation ranges from about 5% to about 30% by weight.

16. The processed animal meat composition of claim 14, wherein the animal meat is selected from the group consisting of a whole muscle piece, comminuted meat, and mechanically deboned meat, and mixtures thereof.

17. The processed animal meat composition of claim 16, wherein the animal meat is fresh or previously frozen from an animal selected from the group consisting of pork, beef, lamb, poultry, fowl, wild game, seafood, and mixtures thereof.

18. The processed animal meat composition of claim 1, further comprising a pH-lowering agent.

19. The processed animal meat composition of claim 18, wherein the pH-lowering agent is lactic acid.

20. The processed animal meat composition of claim 1, further comprising at least one of water, isolated soy protein, antioxidants, spices, and flavorings.

21. A food product comprising the processed animal meat composition of claim 1.

22. A food product comprising the processed animal meat composition of claim 14.

23. The food product of claim 21, wherein the food product is selected from the group consisting of hot dogs, sausages, kielbasa, chorizo, bologna, hams, bacon, luncheon meat products, canned ground meat products, canned emulsified meat products, and mixtures thereof

24. The food product of claim 22, wherein the food product is subjected to a process selected from the group consisting of coating with a batter, coating with a breading, and not coating.

25. The food product of claim 23, wherein the food product is further processed by a method selected from the group consisting of steam cooking, boiling in water, frying, oven cooking, and retorting.
